(19) United States
(12) Patent Application Publication
(10) Pub. No.: US 2021/0035000 A1
(43) Pub. Date: Feb. 4, 2021

(54) DYNAMIC DISTRIBUTION ESTIMATION DEVICE, METHOD, AND PROGRAM

(71) Applicant: NIPPON TELEGRAPH AND TELEPHONE CORPORATION, Tokyo (JP)

(72) Inventors: Masahiro KOJIMA, Tokyo (JP); Hiroshi KIYOTAKE, Tokyo (JP); Tatsushi MATSUBAYASHI, Tokyo (JP); Hisako SHIOHARA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 16/969,052

(22) PCT Filed: Feb. 8, 2019
(86) PCT No.: PCT/JP2019/004677

§ 371 Date: Aug. 11, 2020

(30) Foreign Application Priority Data
Feb. 13, 2018 (JP) 2018-023593

(51) Int. Cl. G06N 7/00

(52) U.S. Cl. CPC G06N 7/005

(57) ABSTRACT

An object is to estimate parameters of a model including censored data at high speed, with a saved memory, and with the parameters having temporal continuity. A responsibility update unit 19 updates a responsibility based on data of a newly observed sample. Then, a moment update unit 20 updates a moment based on the data of the newly observed sample. Then, a statistic update unit 21 updates each statistic based on the responsibility or the moment. Then, a parameter update unit 22 updates a parameter related to a component based on the statistics.

### TECHNICAL FIELD

The present invention relates to dynamic distribution estimation device, method, and program.

### BACKGROUND ART

Censored data refers to data in which, for a sample whose observed value is equal to or greater than a certain threshold (or equal to or less than a certain value), only information indicating that the value is equal to or greater than the threshold but is observed as no specific value is obtained. As such censored data, there are represented a variety of data such as clinical data describing the onset of a disease, death of a person, and the like, contract history data of an Internet line user, and use history data of a service on an e-commerce site. Similarly to the above examples, represented as censored data is also data that is related to the arrival times of spectators in the vicinity of the location of an event, such as a music concert of a famous artist or an international game of a popular sport and is collected on the day of the event. FIG. 7 illustrates a specific example. The total number of expected visitors, which is obtained from the total ticket sales, is represented as N, and the number of visitors observed up to the present time on the day of a concert is represented as M. The arrival time data is obtained for the M people who have arrived, but it is only known that the remaining N-M people have not arrived up to the present time. This is typical censored data.

Techniques for estimating the parameters of a mixture model (batchwise) from censored data are proposed in NPL 2 and NPL 3. Here, as an example, an existing technique of a mixture normal distribution which is one of typical mixture models will be described.

<Model>

Consider a situation in which input data is right censored. Right censoring refers to a condition in which, of samples, a value of a sample the value of which is equal to or greater than a known threshold

C∈ [symbol] [Formula 1]

is unknown. All the data obtained are represented as

[symbol]

={dᵢ}ᵢ₌₁^{N} [Formula 2]

, where dᵢ represents the i-th data, and dᵢ=(wᵢ, Xᵢ) is composed of two: a variable wᵢ∈{0, 1} representing whether or not the value of the i-th sample is observed and an observed value,

Xᵢ(≤C) [Formula 3]

For wᵢ=1, it indicates that a value is observed, and for wᵢ=0, it indicates that no value is observed. Here, N is the total number of samples (including those whose values are not observed), and the number of samples whose values are observed is represented as

M(≤N) [Formula 4]

In the setting considered in this study, a threshold C is known, and two of X and W are observation variables. In general, a probability density function of a mixture model is defined by the following equation.

[Formula 5]

P(x|θ={π,φ})=Σₖ₌₁^{K}πₖfₖ(x|φₖ) (1)

, where K represents the number of components, and

π=(π₁, . . . ,π_{K}),φ=(φ₁, . . . ,φ_{K}) [Formula 6]

represent parameters of the model.

πₖ,φₖ [Formula 7]

represent a mixture ratio of the k-th component and a parameter of the component, respectively. In this paper, consider especially a case where a normal distribution is adopted as the component. (The following discussion is also true for a case of considering a mixture model of a distribution belonging to any exponential distribution family such as an exponential distribution.) A probability density function of the normal distribution is given by the following equation using parameters of two types of components, an average μₖ and a standard deviation σₖ.

$$\begin{matrix}[ Formula 8 ] & \\ f ( x \vert {ϕ}_{k} ) = \frac{1}{\sqrt{2 π {σ}_{k}^{2}}} exp ( - \frac{{( x - {μ}_{k} )}^{2}}{2 {σ}_{k}^{2}} ) . & ( 2 )\end{matrix}$$

Hereinafter, a cumulative density function of the normal distribution is represented by a function F:

[Formula 9]

F(C|φₖ)=∫_{-∞}^{C}f(x|φₖ)dx, (3)

A process of generating censored data includes the following four steps. First, for each data i, a latent variable representing the component to which the i-th data belongs:

zᵢ=(zᵢ₁, . . . ,z_{iK}) [Formula 10]

is generated according to the following polynomial distribution. Note that zᵢₖ=1 for the i-th data belonging to the k-th component, and zᵢₖ=0 for other k′≠k.

[Formula 11]

P(zᵢ|π)=Mult(zᵢ|π)=Πₖ₌₁^{K}πₖ^{z}^{ᵢₖ} (4)

Next, an observation variable wᵢ indicating whether or not a value is observed is generated according to a Bernoulli distribution having a cumulative density function of the following corresponding component as a parameter.

$$\begin{matrix} [ Formula 12 ] & \\ P ( {w}_{i} \vert {z}_{i} , φ ) = {\prod }_{k = 1}^{K} {Bernoulli ( {w}_{i} \vert F ( C \vert {ϕ}_{k} ) )}^{{z}_{ik}} = {\prod }_{k = 1}^{K} {( {F ( C \vert {ϕ}_{k} )}^{{w}_{i}} {( 1 - F ( C \vert {ϕ}_{k} ) )}^{1 - {w}_{i}} )}^{{z}_{ik}} & ( 5 )\end{matrix}$$

Note that the cumulative density

F(C|φₖ) [Formula 13]

represents a probability that the random variable is equal to or less than the threshold C.

Further, for data i with wᵢ=1, that is, with being observable, an observation variable

xᵢ∈(−∞,C) [Formula 14]

is generated according to a truncated normal distribution.

[Formula 15]

P(xᵢ|wᵢ=1,zᵢ,ϕ)=Πₖ₌₁^{K} [symbol] [symbol] (xᵢ|φₖ,−∞,C)^{z}^{ᵢₖ}^{w}^{ᵢ} (6)

Note that the truncated normal distribution

[symbol]

[symbol]

(x|μ,σ²,a,b) [Formula 16]

is defined by the following probability density function that does not take a value outside a range [a, b].

$$\begin{matrix}[ Formula 17 ] & \\ 𝒯𝒩 ( x \vert μ , {σ}^{2} , a , b ) = \frac{f ( x \vert μ , {σ}^{2} )}{F ( b \vert μ , {σ}^{2} ) - F ( a \vert μ , {σ}^{2} )} & ( 7 )\end{matrix}$$

Finally, for the data i with wᵢ=0, that is, with being unobservable, a latent variable yᵢ is generated according to the truncated normal distribution.

$$\begin{matrix}[ Formula 18 ] & \\ P ( {y}_{i} \vert {w}_{i} = 0 , {z}_{i} , ϕ ) = {\prod }_{k = 1}^{K} {𝒯𝒩 ( {y}_{i} \vert {ϕ}_{k} , C , ∞ )}^{{z}_{ik} ( 1 - {w}_{i} )} & ( 8 )\end{matrix}$$

By repeating the above for all data i, observed variables X and W and latent variables Z and Y are generated.

Hereafter, for the sake of simplicity of notation, it is assumed that the generated data is rearranged so that for

1≤i≤M [Formula 19]

, wᵢ=1, and for

M+1≤j≤N [Formula 20]

, wⱼ=0. Accordingly, a likelihood function of the complete data is given by the following equation using Equations (4), (5), (6), and (8):

$$\begin{matrix} [ Formula 21 ] & \\ P ( X , W , Y , Z \vert θ ) = ( {\prod }_{i = 1}^{𝒩} P ( {z}_{i} \vert π ) P ( {w}_{i} \vert {z}_{i} , ϕ ) ) \cdot ( {\prod }_{i = 1}^{M} P ( {x}_{i} \vert {w}_{i} , {z}_{i} , ϕ ) ) ( {\prod }_{j = M + 1}^{𝒩} P ( {y}_{j} \vert {w}_{j} , {z}_{j} , ϕ ) ) & ( 9 )\end{matrix}$$

<Batch Type EM Algorithm>

The Expectation-Maximization (EM) algorithm is a technique widely used for estimating a model including latent variables. It is composed of two steps: an E-step of calculating posterior probabilities of latent variables and calculating expected values using them, and an M-step of maximizing a function called a Q-function, which is an average of log likelihood functions with respect to posterior probabilities of latent variables.

In the E-step of this model, two posterior probabilities, P(zᵢ|xᵢ, wᵢ=1, θ) when an observed value is obtained and P(zᵢ|xᵢ, wᵢ=0, θ) when no observed value is obtained, are required, and each is given by the following equation:

$$P ( {z}_{i} \vert {x}_{i} , {w}_{i} = 1 , θ ) = \frac{P ( {z}_{i} , {x}_{i} \vert {w}_{i} = 1 , θ )}{P ( {x}_{i} \vert {w}_{i} = 1 , θ )} = \frac{{π}_{k} f ( {x}_{i} \vert {ϕ}_{k} )}{{\sum }_{{k}^{′}} {π}_{k} f ( {x}_{i} \vert {ϕ}_{{k}^{′}} )} , \\ P ( {z}_{j} , {y}_{j} \vert {w}_{j} = 0 , θ ) = P ( {z}_{j} \vert {w}_{j} = 0 , θ ) P ( {y}_{j} \vert {w}_{j} = 0 , {z}_{j} , φ ) \\ P ( {z}_{j} \vert {w}_{j} = 0 , θ ) = \frac{P ( {z}_{j} , {w}_{j} = 0 \vert θ )}{P ( {z}_{j} = 0 \vert θ )} = \frac{{π}_{k} ( 1 - F ( C \vert {ϕ}_{k} ) )}{{\sum }_{{k}^{′}} {π}_{{k}^{′}} ( 1 - F ( C \vert {ϕ}_{{k}^{′}} ) )} . \qquad [ Formula 22 ]$$

Using the above posterior probabilities, responsibilities γ, η of zᵢ, zⱼ and a moment {vₖ, ξₖ} of yⱼ can be calculated by the following equation.

$$\begin{matrix}[ Formula 23 ] & \\ γ ( {z}_{ik} ) = \frac{{π}_{k} f ( {x}_{i} \vert {ϕ}_{k} )}{{\sum }_{{k}^{′}} {π}_{k} f ( {x}_{i} \vert {ϕ}_{{k}^{′}} )} , & ( 10 ) \\ η ( {z}_{jk} ) = \frac{{π}_{k} ( 1 - F ( C \vert {ϕ}_{k} ) )}{{\sum }_{{k}^{′}} {π}_{{k}^{′}} ( 1 - F ( C \vert {ϕ}_{{k}^{′}} ) )} , & ( 11 ) \\ {v}_{k} ( {y}_{j} \text{:} C ) = {𝔼}_{{y}_{j}} [ {y}_{j} ] = {μ}_{k} + {( {σ}_{k} )}^{2} \frac{f ( C \vert {ϕ}_{k} )}{1 - F ( C \vert {ϕ}_{k} )} , & ( 12 ) \\ {ξ}_{k} ( {y}_{j} \text{:} C ) = {𝔼}_{{y}_{j}} [ {y}_{j}^{2} ] = {μ}_{k}^{2} + {σ}_{k}^{2} + {( {σ}_{k} )}^{2} \frac{( C + {μ}_{k} ) f ( C \vert {ϕ}_{k} )}{1 - F ( C \vert {ϕ}_{k} )} , & ( 13 )\end{matrix}$$

Here,

[symbol]

_{y}_{ⱼ} [Formula 24]

represents an average related to a posterior probability,

P(yⱼ|wⱼ=0,zⱼ,ϕ) [Formula 25]

For this averaging operation, the results of the first moment and the second moment of the truncated normal distribution are used. Also, as is apparent from Equations (12) and (13),

vₖ(yⱼ;C),ξₖ(yⱼ;C) [Formula 26]

is hereinafter represented as

vₖ(y;C),ξₖ(y;C) [Formula 27]

because it does not depend on the subscript j. Using these, a Q-function to be maximized in the M-step is represented by the following equation.

$$\begin{matrix} [ Formula 28 ] & \\ Q ( θ , {θ}^{old} ) = {𝔼}_{Z , Y \vert X , W , {θ}^{old}} [ log P ( X , W , Y , Z \vert θ ) ] & ( 14 ) \\ = {\sum }_{k = 1}^{K} {N}_{k} log {π}_{k} + {\sum }_{k = 1}^{K} - \frac{{N}_{k}}{2} log ( 2 π {σ}_{k}^{2} ) + {\sum }_{k = 1}^{K} - \frac{1}{2 {σ}_{k}^{2}} \{ {S}_{k 2} - 2 {S}_{k 1} {μ}_{k} + {M}_{k} {μ}_{k}^{2} \} + {\sum }_{k = 1}^{K} - \frac{1}{2 {σ}_{k}^{2}} \{ {U}_{k 2} - 2 {U}_{k 1} {μ}_{k} + ( {N}_{k} - {M}_{k} ) {μ}_{k}^{2} \} . & ( 15 )\end{matrix}$$

Here,

[Formula 29]

Mₖ=Σⱼ₌₁^{M}γ(z₁ₖ),Nₖ=Mₖ+(Nₖ−Mₖ)η(zⱼₖ), (16)

Sₖ₁=Σᵢ₌₁^{M}γ(zᵢₖ)xᵢ,Sₖ₂=Σᵢ₌₁^{M}γ(zᵢₖ)rᵢ², (17)

Uₖ₁=Σ_{j=M+1}^{M}γ(zⱼₖ)vₖ(y)=(Nₖ−Mₖ)vₖ(y;C), (18)

Uₖ₂=Σ_{j=M+1}^{M}γ(zⱼₖ)ξₖ(y)=(Nₖ−Mₖ)ξₖ(y;C), (19)

Parameters that maximize the Q-function when solved with the partial derivatives set to zero are given as

$$\begin{matrix}[ Formula 30 ] & \\ {π}_{k}^{new} = \frac{{N}_{k}}{N} , & ( 20 ) \\ {μ}_{k}^{new} = \frac{1}{{N}_{k}} ( {S}_{k 1} + {U}_{k 1} ) , & ( 21 ) \\ {( {σ}_{k}^{new} )}^{2} = \frac{1}{{N}_{k}} ( {S}_{k 2} + {U}_{k 2} ) - \frac{1}{{N}_{k}^{2}} {( {S}_{k 1} + {U}_{k 1} )}^{2} , & ( 22 )\end{matrix}$$

As a result, a batch type EM algorithm for a mixture model for censored data has been desired. Procedures are summarized in Algorithm 1 shown below. Updating the parameters is repeated through the E-step and the M-step, and in each iteration, the log likelihood function monotonically increases so that convergence to the (local) optimal solution is guaranteed.

TABLE 1
Algorithm 1 Batch type EM Algorithm for Gaussian mixture model
for Censored data

```
Input: X, W: input data, C: (right) censored value, K: number
of mixed models
Output: θ = {πₖ, μₖ, σₖ}^{K}^{ₖ₌₁}: parameters for maximizing
likelihood function
  Initialize parameters {πₖ, μₖ, σₖ}
  repeat
    E-step: Update responsibilities γ(zᵢ), η(zⱼ) using current
    parameters according to Equations (10) (11), and moments
    νₖ {yⱼ; C), ξₖ(yⱼ; C) according to Equations (12) (13)
    M-step: Calculate statistics Mₖ, Nₖ, Sₖ₁, Sₖ₂, Uₖ₁, Uₖ₂ using
    current responsibilities according to Equations
    (16) (17) (18) (19), and Update parameter θ according to
    Equations (20) (21) (22)
  until Repeat until convergence conditions are satisfied
```

### CITATION LIST

### Non Patent Literature

[NPL 1] Didier Chauveau., “Astochastic em algorithm for mixtures with censored data.”, Journal of statistical planning inference, 46(1): p. 1-25, 1995.
[NPL 2] Gyemin Lee and Clayton Scott. “Em algorithms for multivariate gaussian mixture models with truncated and censored data.”, Computational Statistics & Data Analysis, 56(9): p. 2816-2829, 2012.

### SUMMARY OF THE INVENTION

### Technical Problem

Existing techniques are only able to perform batch type estimation on censored data.

The present invention has been made in view of the above circumstances, and it is an object of the present invention to provide dynamic distribution estimation device, method, and program capable of estimating parameters of a model including censored data at high speed, with a saved memory, and with the parameters having temporal continuity.

### Means for Solving the Problem

In order to achieve the above object, a dynamic distribution estimation device according to the present invention is for estimating parameters of a mixture model online, the mixture model being a mixture of arbitrary distributions belonging to an exponential distribution family and representing a distribution of data to be observed. The dynamic distribution estimation device includes an expected value update unit that updates, in a case of assuming that data of each of unobserved samples belongs to each component, an expected value for a distribution, having a sufficient statistic for the data of the unobserved sample, of a truncated component, based on data of a newly observed sample; a statistic update unit that updates a statistic related to each component based on the data of the newly observed sample and the expected value updated by the expected value update unit; and a parameter update unit that updates, for each component, a parameter related to the component based on the statistic updated by the statistic update unit, wherein updating by the expected value update unit, updating by the statistic update unit, and updating by the parameter update unit are repeated each time a predetermined parameter update timing is reached.

Further, a dynamic distribution estimation device according to the present invention is for estimating parameters of a Gaussian mixture model online, the Gaussian mixture model being for a mixture of a plurality of components and representing a distribution of data to be observed. The dynamic distribution estimation device includes a responsibility update unit that updates, based on data of a newly observed sample, a responsibility that indicates a degree to which the data of the newly observed sample belongs to each component, and a responsibility that indicates a degree to which data of each of unobserved samples belongs to each component; a moment update unit that updates, in a case of assuming that the data of each of the unobserved samples belongs to each component, a moment of the data of the unobserved sample; a statistic update unit that updates a statistic for the number of samples belonging to each component among observed samples based on the responsibility that indicates a degree to which the data of the newly observed sample belongs to each component, updates a statistic for the number of samples belonging to each component among all samples based on the responsibility that indicates a degree to which the data of each of the unobserved samples belongs to each component, updates, for each component, a statistic for data of the observed sample belonging to the component based on the responsibility that indicates a degree to which the data of the newly observed sample belongs to each component, and updates, for each component, in a case of assuming that data of each newly observed sample belongs to each component, a statistic for data of the unobserved sample belonging to the component based on the moment of the data of the unobserved sample, the statistic for the number of samples belonging to the component among the observed samples, and the statistic for the number of samples belonging to the component among all the samples; and a parameter update unit that updates, for each component, a parameter related to the component based on the statistic for the number of samples belonging to the component among all the samples, the statistic for the data of the observed sample belonging to the component, and the statistic for the data of the unobserved sample belonging to the component, wherein updating by the responsibility update unit, updating by the moment update unit, updating by the statistic update unit, and updating by the parameter update unit are repeated each time a predetermined parameter update timing is reached.

A dynamic distribution estimation device according to the present invention is for estimating parameters of a mixture model online, the mixture model being a mixture of arbitrary distributions that each represent a distribution of data to be observed and belong to an exponential distribution family. The dynamic distribution estimation device includes a latent variable parameter update unit that updates, based on data of a newly observed sample, a parameter of a variational distribution related to a latent variable of each component for data of the newly observed sample and a parameter of a variational distribution related to a latent variable of each component for data of a set of already observed samples including the newly observed sample; a statistic update unit that updates a statistic for the number of samples belonging to each component among observed samples based on the parameter of the variational distribution for each component for the data of the newly observed sample, updates a statistic for the number of samples belonging to each component among unobserved samples based on the parameter of the variational distribution for each component for the data of the set of already observed samples, updates, for each component, a statistic for data of the observed sample belonging to the component based on the parameter of the variational distribution for each component for the data of the newly observed sample, and updates, based on the data of the set of already observed samples and the statistic for the number of samples belonging to each component among the unobserved samples, the statistic for the data of the unobserved sample belonging to the component; and a parameter update unit that updates, for each component, a parameter of a variational distribution related to a parameter of the component based on the number of samples belonging to the component among all samples, the statistic for the data of the observed sample belonging to the component, and the statistic for the data of the unobserved sample belonging to the component, wherein updating by the latent variable parameter update unit, updating by the statistic update unit, and updating by the parameter update unit are repeated each time a predetermined parameter update timing is reached.

The parameter update timing of the present invention can be any one of a timing at which the data of the newly observed sample is obtained, a timing at which a predetermined number of pieces of data of the newly observed sample are obtained, and a timing when a predetermined update time is reached.

A dynamic distribution estimation method of the present invention is a dynamic distribution estimation device for estimating parameters of a mixture model online, the mixture model being a mixture of arbitrary distributions belonging to an exponential distribution family and representing a distribution of data to be observed. The dynamic distribution estimation method includes the steps of: by an expected value update unit, updating, in a case of assuming that data of each of unobserved samples belongs to each component, an expected value for a distribution, having a sufficient statistic for the data of the unobserved sample, of a truncated component, based on data of a newly observed sample; by a statistic update unit, updating a statistic related to each component based on the data of the newly observed sample and the expected value updated by the expected value update unit; and by a parameter update unit, updating, for each component, a parameter related to the component based on the statistic updated by the statistic update unit, wherein updating by the expected value update unit, updating by the statistic update unit, and updating by the parameter update unit are repeated each time a predetermined parameter update timing is reached.

A dynamic distribution estimation method of the present invention is for a dynamic distribution estimation device estimating parameters of a Gaussian mixture model online, the Gaussian mixture model being for a mixture of a plurality of components and representing a distribution of data to be observed. The dynamic distribution estimation method includes the steps of: by a responsibility update unit, updating, based on data of a newly observed sample, a responsibility that indicates a degree to which the data of the newly observed sample belongs to each component, and a responsibility that indicates a degree to which data of each of unobserved samples belongs to each component; by a moment update unit, updating, in a case of assuming that the data of each of the unobserved samples belongs to each component, a moment of the data of the unobserved sample; by a statistic update unit, updating a statistic for the number of samples belonging to each component among observed samples, based on the responsibility that indicates a degree to which the data of the newly observed sample belongs to each component, updating a statistic for the number of samples belonging to each component among all samples, based on the responsibility that indicates a degree to which the data of each of the unobserved samples belongs to each component, updating, for each component, a statistic for data of the observed sample belonging to the component based on the responsibility that indicates a degree to which the data of the newly observed sample belongs to each component, and updating, for each component, in a case of assuming that data of each newly observed sample belongs to each component, a statistic for data of the unobserved sample belonging to the component based on the moment of the data of the unobserved sample, the statistic for the number of samples belonging to the component among the observed samples, and the statistic for the number of samples belonging to the component among all the samples; and by a parameter update unit, updating, for each component, a parameter related to the component based on the statistic for the number of samples belonging to the component among all the samples, the statistic for the data of the observed sample belonging to the component, and the statistic for the data of the unobserved sample belonging to the component, wherein updating by the responsibility update unit, updating by the moment update unit, updating by the statistic update unit, and updating by the parameter update unit are repeated each time a predetermined parameter update timing is reached.

A dynamic distribution estimation method of the present invention is for a dynamic distribution estimation device estimating parameters of a mixture model online, the mixture model being a mixture of arbitrary distributions that each represent a distribution of data to be observed and belong to an exponential distribution family. The dynamic distribution estimation method includes the steps of: by a latent variable parameter update unit, updating, based on data of a newly observed sample, a parameter of a variational distribution related to a latent variable of each component for data of the newly observed sample and a parameter of a variational distribution related to a latent variable of each component for data of a set of already observed samples including the newly observed sample; by a statistic update unit, updating a statistic for the number of samples belonging to each component among observed samples based on the parameter of the variational distribution for each component for the data of the newly observed sample, updating a statistic for the number of samples belonging to each component among unobserved samples based on the parameter of the variational distribution for each component for the data of the set of already observed samples, updating, for each component, a statistic for data of the observed sample belonging to the component based on the parameter of the variational distribution for each component for the data of the newly observed sample, and updating, based on the data of the set of already observed samples and the statistic for the number of samples belonging to each component among the unobserved samples, the statistic for the data of the unobserved sample belonging to the component; and by a parameter update unit, updating, for each component, a parameter of a variational distribution related to a parameter of the component based on the number of samples belonging to the component among all samples, the statistic for the data of the observed sample belonging to the component, and the statistic for the data of the unobserved sample belonging to the component, wherein updating by the latent variable parameter update unit, updating by the statistic update unit, and updating by the parameter update unit are repeated each time a predetermined parameter update timing is reached.

A program according to the present invention is a program for functioning as the units of the dynamic distribution estimation device of the present invention.

### Effects of the Invention

As described above, according to the dynamic distribution estimation device, method, and program of the present invention, by estimating parameters of an arbitrary distribution being for a mixture of a plurality of components and belonging to an exponential distribution family, an effect is obtained, capable of estimate parameters of a model including censored data at high speed, with a saved memory, and with the parameters having temporal continuity.

### BRIEF DESCRIPTION OF DRAWINGS

FIG. 1 is an explanatory diagram for describing a sequential update online algorithm.

FIG. 22 is an explanatory diagram for describing an update timing.

FIG. 3 is a schematic diagram illustrating a configuration example of a dynamic distribution estimation device according to a first embodiment.

FIG. 4 is a flowchart illustrating the contents of a dynamic distribution estimation process routine in the dynamic distribution estimation device according to the first embodiment.

FIG. 5 is a schematic diagram illustrating a configuration example of a dynamic distribution estimation device according to a second embodiment.

FIG. 6 is a flowchart illustrating the contents of a dynamic distribution estimation process routine in the dynamic distribution estimation device according to the second embodiment.

FIG. 7 is an explanatory diagram for describing censored data.

### DESCRIPTION OF EMBODIMENTS

Hereinafter, embodiments of the present invention will be described in detail with reference to the drawings.

<Outline of Embodiments of the Present Invention>

In a situation where data is being collected on the day of an event, as time passes, data on newly arrived spectators can be observed, and the data is constantly updated. In estimating the model parameters of an arrival time distribution in such a situation, an online algorithm is useful which updates parameters sequentially with newly arrived data reflected (e.g., see a reference (Olivier Cappe and Eric Moulines. “On-line expectation-maximization algorithm for latent data models.”, Journal of the Royal Statistical Society: Series B (Statistical Methodology), 71(3) p. 593-613, 2009)).

Therefore, in an embodiment of the present invention, an online EMCM algorithm (online EM algorithm for Censored Mixture models), which is an algorithm for estimating the model parameters of the arrival time online from censored data that is constantly updated, is constructed. This technique has an advantage over the batch type method in the following three points.

(1) Memory Saving

The proposed algorithm of the present embodiment can update the parameters only with sufficient statistics held, and does not need to hold all the arrival times of the arrived spectators. This is also good from a privacy standpoint.

(2) High Speed

The proposed algorithm of the present embodiment is updated using the above-described statistics and the amount calculated from newly observed data. The proposed algorithm of the present embodiment can perform a parameter update process in less steps than the batch type method in which calculation is performed using all data. Particularly, in concerts and sport events as described above, the number of visitors is the order of tens of thousands, and it is preferable to avoid the batch process using all data at each time.

(3) Estimated Parameters Having Temporal Continuity

A parameter output at each time by the proposed algorithm of the present embodiment is a value continuously varying from the parameter at the previous time. If a process of re-applying the batch type method is performed at each time, a local optimal solution having a different objective function may be reached, resulting in an output of a parameter completely different from that at the previous time, which is not preferable in practice. By contrast, the present embodiment does not have such a problem.

In the present embodiment, three types of algorithms: (a) sequential update type, (b) mini-batch type, and (c) schedule type, which have different parameter update timings so as to match more various real system implementations are provided. These three are all algorithms having the above-described three advantages. This makes it possible to use the present technique in any of the cases where the parameters are updated immediately when new data is obtained, where the parameters are updated after some pieces of related data have been collected, and where the parameters are updated at a fixed timing. Also, although the above-described example is for estimation of the arrival time distribution, the present embodiment can be widely used for estimation of the parameters of censored data.

Note that, in the present embodiment, a mixture model is adopted as a model of the arrival time. This is because it is expected that, in the events as described above, a distribution of the arrival times of spectators has multi-modality depending on whether they purchase goods such as artist goods and uniforms before the start of the event, or they are just in time for the start of the event.

Note that the present embodiment can be applied almost in the same manner even for a mixture model of a probability distribution other than a normal distribution such as an exponential distribution or a lognormal distribution.

The batch type EM algorithm of Algorithm 1 calculates responsibilities for all data in the memory in the E-step, and uses them to repeatedly calculate statistics,

Nₖ,Sₖ₁,Sₖ₂ [Formula 31]

in the M-step. This means that it is necessary to hold all the values of data X in the memory and to read out the entire memory at each iteration. On the other hand, the online EMCM algorithm, which is our proposed algorithm (online Expectation-Maximization algorithm for Censored Mixture models), uses only newly observed data without having held all the data in the memory, and calculates responsibilities and statistics to update the parameters.

<Sequential Update Type Online EM Algorithm>

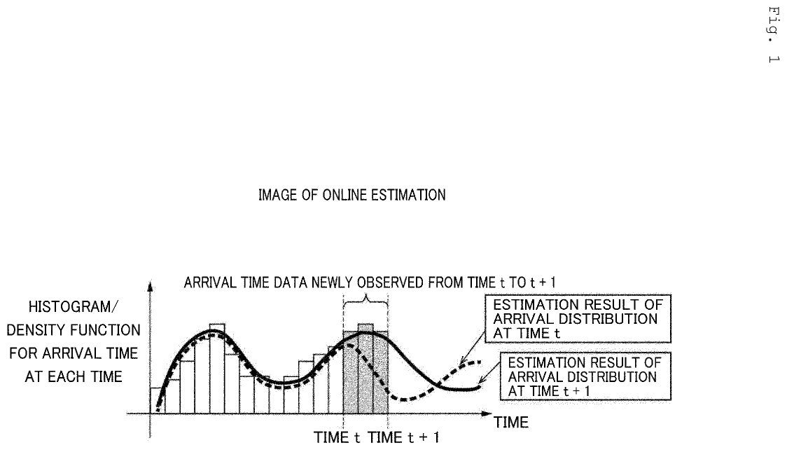

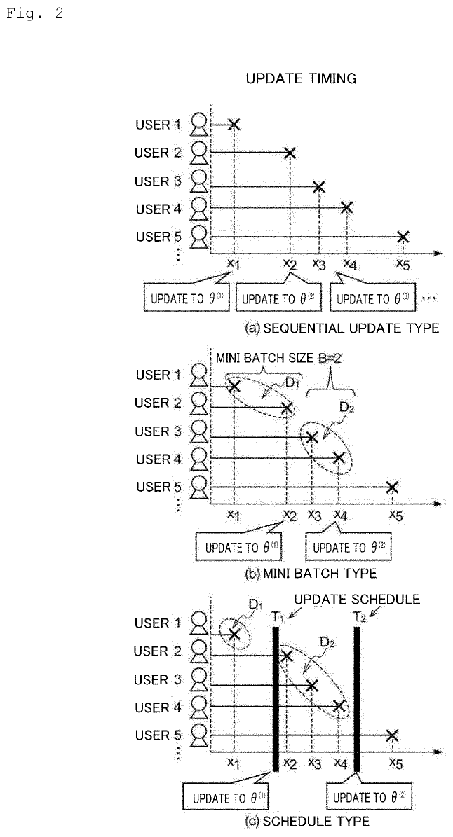

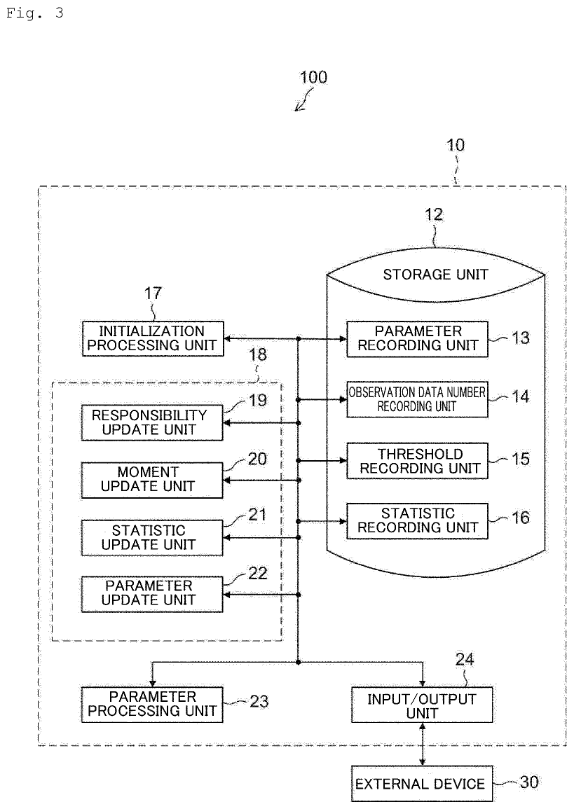

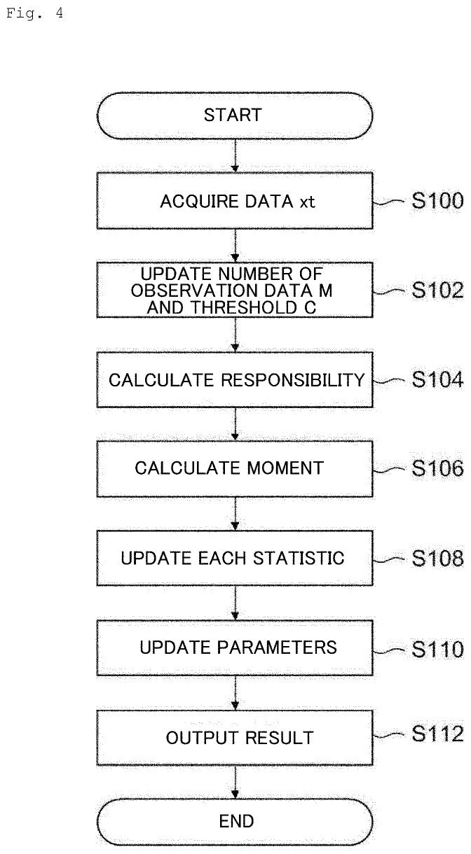

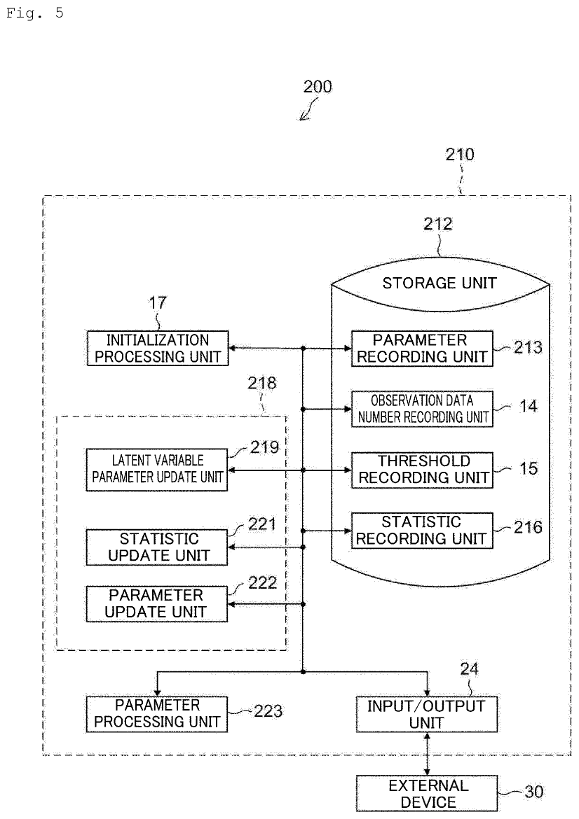

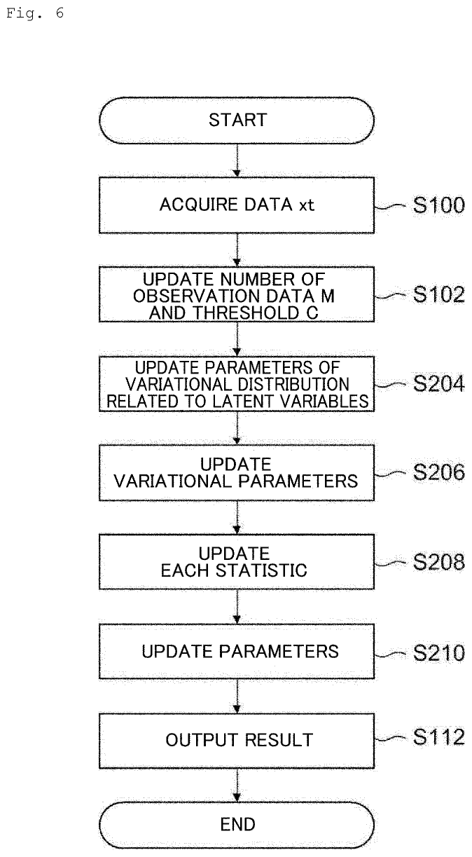

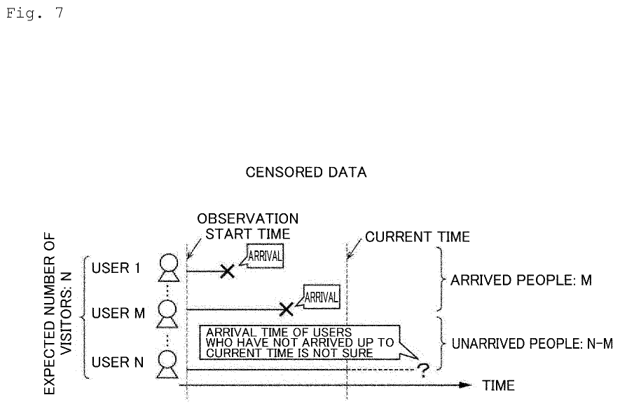

First, a sequential update type algorithm that updates parameters each time data xₜ is newly observed will be described. In the algorithm, the data observation and the update timing coincide as illustrated in FIG. 1. The proposed algorithm is derived taking advantage of the batch type algorithm enabling statistics to be expressed in sequential form. When a statistic at the time when data xₜ₋₁ is observed is represented by a superscript (t−1), specific sequential calculation equations are given by the following:

Mₖ^{(t)}=Mₖ^{(t-1)}+γ(zₜₖ), (23)

Nₖ^{(t)}=Mₖ^{(t)}+(N−M)η(zⱼₖ), (24)

Sₖ₁^{(t)}=Sₖ₁^{(t-1)}+γ(zₜₖ)xₜ, (25)

Sₖ₂^{(t)}=Sₖ₂^{(t-1)}+γ(zₜₖ)xₜ², (26)

Uₖ₁^{(t)}=(Nₖ^{(t)}−Mₖ^{(t)})vₖ(y:xₜ), (27)

Uₖ₂^{(t)}=(Nₖ^{(t)}−Mₖ^{(t)})ξₖ(yⱼ:xₜ), (28)

First, in the E-step, responsibilities to be calculated using the new observation data xₜ are calculated. Observation of this data indicates that unobserved data at that time is also equal to or greater than xₜ, and moments are calculated accordingly. After that, in the M-step, the statistics are calculated using the above-described sequential equations to update the parameters. By performing these each time new data arrives, the parameters are estimated. A procedure of the proposed algorithm is summarized in Algorithm 2.

TABLE 2
Algorithm 2 Online EM Algorithm (Sequential type) for Censored
data

```
Input: N: number of data, K: number of mixed models
Output: {θ^{(t)}}^{N}^{ₜ₌₁}
  1: Initialize parameters {πₖ⁽⁰⁾, μₖ⁽⁰⁾, σₖ⁽⁰⁾} and statistics
Mₖ⁽⁰⁾, Sₖ₁⁽⁰⁾, Sₖ₂⁽⁰⁾
  2: Initialize number of observed data M ← 0
  3: for t = 1 to N do
  4: Acquire data xₜ
  5: Update number of data and threshold: M ← M + 1, C ← xₜ
  6: E-step: Calculate responsibilities γ(zᵢ), η(zⱼ) of data
    xt according to Equations (10) (11) , and moments νₖ(yⱼ; xₜ),
    ξₖ(yⱼ; xₜ) according to Equations (12) (13)
  7: M-step: Update/Calculate statistics Mₖ^{(t)}, Nₖ^{(t)}, Sₖ₁^{(t)},
    Sₖ₂^{(t)}, Uₖ₁^{(t)}, Uₖ₂^{(t)} using the responsibilities according
    to Equations (23) (24) (25) (26) (27) (28), and Update
    parameter θ^{(t)} according to Equations (20) (21) (22) using
    the statistics
  8: end for
```

<Mini-Batch Type and Schedule Type Algorithms>

In the previous section, the parameters are updated each time the data is updated. However, data every time is not necessarily required, and algorithms with different parameter update timings can be derived so as to be adapted to various real system implementations. Therefore, in this section, in addition to (a) the sequential update type in the previous section, two types of algorithms, (b) a mini-batch type and (c) a schedule type illustrated in FIG. 2 are provided.

First, the mini-batch type will be described. In this method, the number B of data to be stored before parameter update (which is referred to as a mini-batch size) is determined in advance, and the parameter update is performed at the time when the number of data is stored. In the calculation of the E-step, the M-step obtains data on responsibilities and moment calculated from the mini-batch as described below, and updates the statistics as described below. Since the number of executions of the M-step is reduced as compared with the sequential update type, the processing time can be further reduced.

$$\begin{matrix}[ Formula 33 ] & \\ {M}_{k}^{( 𝓁 )} = {M}_{k}^{( 𝓁 - 1 )} + {\sum }_{t ∈ {𝒟}_{𝓁}} γ ( {z}_{tk} ) , & ( 29 ) \\ {N}_{k}^{( 𝓁 )} = {M}_{k}^{( 𝓁 )} + ( N - M ) η ( {z}_{jk} ) , & ( 30 ) \\ {S}_{k 1}^{( 𝓁 )} = {S}_{k 1}^{( 𝓁 - 1 )} + {\sum }_{t ∈ {𝒟}_{𝓁}} γ ( {z}_{tk} ) {x}_{t} , & ( 31 ) \\ {S}_{k 2}^{( 𝓁 )} = {S}_{k 2}^{( 𝓁 - 1 )} + {\sum }_{t ∈ {𝒟}_{𝓁}} γ ( {z}_{tk} ) {x}_{t}^{2} , & ( 32 ) \\ {U}_{k 1}^{( 𝓁 )} = ( {N}_{k}^{( 𝓁 )} - {M}_{k}^{( 𝓁 )} ) {v}_{k} ( y \text{:} { max }_{{x}_{t} ∈ {𝒟}_{𝓁}} {x}_{t} ) , & ( 33 ) \\ {U}_{k 2}^{( 𝓁 )} = ( {N}_{k}^{( 𝓁 )} - {M}_{k}^{( 𝓁 )} ) {ξ}_{k} ( {y}_{j} \text{:} {max}_{{x}_{t} ∈ {𝒟}_{𝓁}} {x}_{t} ) , & ( 34 )\end{matrix}$$

A procedure of the proposed algorithm is summarized in Algorithm 3. Note that the symbol,

└·┘ [Formula 34]

represents a floor function that returns an integer not exceeding an input value. Next, (c) the schedule type will be described. The algorithm is almost the same as (b) the mini-batch type.

TABLE 3
Algorithm 3 Online EM Algorithm (Mini-batch type) for Censored
data

```
Input: N: number of data, K: number of mixed models, B:
mini-batch size
Output: {θ^{(l)}}^{L}^{ₗ₌₁}
  1: Initialize parameters {πₖ⁽⁰⁾, μₖ⁽⁰⁾, σₖ⁽⁰⁾} and statistics
Mₖ⁽⁰⁾, Sₖ₁⁽⁰⁾, Sₖ₂⁽⁰⁾
  2: Initialize number of observed data M ← 0
  3: for l = 1 to [N/B] do
  4: Acquire data D₁
  5: Update number of data and threshold: M ← M + B, C ←
max_(xₜϵD₁) xₜ
  6: E-step: Calculate responsibilities γ(zᵢ), η(zⱼ) of data
    xₜ according to Equations (10) (11), and moments νₖ(yⱼ; C),
    ξₖ(yⱼ; C) according to Equations (12) (13)
  7: M-step: Update/Calculate statistics Mₖ^{(l)}, Nₖ^{(l)}, Sₖ₁^{(l)},
    Sₖ₂^{(l)}, Uₖ₁^{(l)}, Uₖ₂^{(l)} using the responsibilities according
    to Equations (29) (30) (31) (32) (33) (34), and Update
    parameter θ⁽¹⁾ according to Equations (20) (21) (22) using
    the statistics
  8: end for
```

Here, the statistics,

[symbol]

, [symbol] [Formula 35]

are different.

[Formula 36]

[symbol]

=( [symbol] − [symbol] )vₖ(y;Tₗ), (35)

[symbol]

=( [symbol] − [symbol] )ξₖ(yj;Tₗ). (36)

A procedure of the proposed algorithm is summarized in Algorithm 4. Note that a method in which all or some of the update methods following the above three types of algorithms are mixed, for example, a method using both the mini-batch and the update schedule can be similarly constructed, but is omitted herein.

TABLE 4
Algorithm 4 Online EM Algorithm (Schedule type) for Censored
data

```
Input: N: number of data, K: number of mixed models, L: number
of updates, Update schedule: T₁, T₂, . . . , T_{L}
Output: {θ^{(l)}}^{L}^{ₗ₌₁}
  1: Initialize parameters {πₖ⁽⁰⁾, μₖ⁽⁰⁾, σₖ⁽⁰⁾} and statistics
Mₖ⁽⁰⁾, Sₖ₁⁽⁰⁾, Sₖ₂⁽⁰⁾
  2: Initialize number of observed data M ← 0
  3: for l = 1 to L do
  4: Acquire data D₁
  5: Update number of data and threshold: M ← M + |D₁|, C ←
T₁
  6: E-step: Calculate responsibilities γ(zᵢ), η(zⱼ) of data
    xₜ according to Equations (10) (11) , and moments νₖ(yⱼ; C),
    ξₖ(yⱼ; C) according to Equations (12) (13)
  7: M-step: Update/Calculate statistics Mₖ^{(l)}, Nₖ^{(l)}, Sₖ₁^{(l)},
    Sₖ₂^{(l)}, Uₖ₁^{(l)}, Uₖ₂^{(l)} using the responsibilities according
    to Equations (29) (30) (31) (32) (35) (36), and Update
    parameter θ^{(l)} according to Equations (20) (21) (22) using
    the statistics
  8: end for
```

<Sequential Update Online Variational Bayes Algorithm>

In the above description, the online EM algorithm that is an extension of the batch type EM algorithm is shown. In addition to the EM algorithm, there is an algorithm called a variational Bayes (VB) algorithm as an estimation algorithm fora mixture model, and the VB algorithm can be an online algorithm through the same approach as the present invention. Therefore, the scope of the present invention is not limited to the online EM algorithm, but includes all online estimation algorithms for a mixture model for censored data. Hereinafter, an example of deriving a sequential update type algorithm based on the batch type algorithm of the VB algorithm will be described below.

<Batch Type Variational Bayes (VB) Algorithm>

In the variational Bayes algorithm, it is considered that, for the parameters of the model,

θ={π,μ,λ} [Formula 37]

, a prior distribution,

P(θ)=P(π)P(μ,λ) [Formula 38]

is set. Here,

λ={λₖ}ₖ₌₁^{K} [Formula 39]

is a precision parameter, and in this chapter, in place of a standard deviation,

σₖ² [Formula 40]

, a precision,

λₖ [Formula 41]

is used so that

$$f ( x \vert {μ}_{k} , {λ}_{k}^{- 1} ) = \sqrt{\frac{{λ}_{k}}{2 π}} exp ( - \frac{{λ}_{k}}{2} {( x - {μ}_{k} )}^{2} ) \qquad [ Formula 42 ]$$

represents a probability density function of the normal distribution.

P(π) and P(μ,λ) [Formula 43]

are a (symmetric) Dirichlet distribution and a normal-gamma distribution, respectively, and are defined by the following equations.

$$\begin{matrix} [ Formula 44 ] & \\ P ( π ) = Dirichlet ( π \vert {α}_{0} ) = \frac{Γ ( K {α}_{0} )}{{Γ ( {α}_{0} )}^{K}} {\prod }_{k = 1}^{K} {π}_{k}^{{α}_{0} - 1} , & ( 37 ) \\ P ( μ , λ ) = {\prod }_{k = 1}^{K} 𝒩 ( {μ}_{k} \vert {μ}_{0} , {( {τ}_{0} {λ}_{k} )}^{- 1} ) Gam ( {λ}_{k} , {a}_{0} , {b}_{0} ) & ( 38 ) \\ = {\prod }_{k = 1}^{K} \sqrt{\frac{{τ}_{0} {λ}_{k}}{2 π}} exp ( - \frac{{τ}_{0} {λ}_{k}}{2} {( {μ}_{k} - {μ}_{0} )}^{2} ) \frac{1}{Γ ( {a}_{0} )} {b}_{0}^{{a}_{0}} {λ}_{k}^{{a}_{0} - 1} exp ( - {b}_{0} {λ}_{k} ) . & ( 39 )\end{matrix}$$

By combining the above equation and Equation (9), a generation probability of the parameters and the complete data is represented by the following equation.

[Formula 45]

P(X,W,Y,Z,θ)=P(X,W,Y,Z|θ)P(θ) (40)

The (batch type) VB algorithm is a method of estimating a variational distribution that approximates a posterior distribution of the parameters and the latent variables. In the VB algorithm for censored data, it is considered that, under the condition that the variational distribution is decomposed into

q(π,μ,λ,Y,Z)=q(π)q(μ,λ)q(Y,Z), [Formula 46]

, a functional,

[symbol]

[q] [Formula 47]

is minimized to estimate the variational distribution.

$$\overline{F} [ q ] = {𝔼}_{q} [ log \frac{q ( π ) q ( μ , λ ) q ( Y , Z )}{p ( X , W , Y , Z , θ )} ] \qquad ( 41 )$$

Analysis by a variational method indicates that a desired variational distribution needs to satisfy the following optimality conditions:

[Formula 49]

q(π)∝exp( [symbol] _{q(μ,λ)q(Y,Z)}[log P(X,W,Y,Z,θ)]),

q(μ,λ)∝exp( [symbol] _{q(π)q(Y,Z)}[log P(X,W,Y,Z,θ)]),

q(Y,Z)∝exp( [symbol] _{q(π)q(μ,λ)}[log P(X,W,Y,Z,θ)]), (42)

Calculating the above, (optimal) variational distributions of

π,μ,λ,Y,Z [Formula 50]

are shown to be given by the following Dirichlet distribution, normal-gamma distribution, and polynomial-truncated normal distribution, respectively:

$$\begin{matrix}[ Formula 51 ] & \\ q ( π ) = Dirichlet ( π \vert {α}_{k} ) , & ( 43 ) \\ {α}_{k} = {α}_{0} + {\overline{M}}_{k} + {\overline{L}}_{k} , & ( 44 ) \\ q ( μ \vert λ ) = {\prod }_{k = 1}^{K} 𝒩 ( {μ}_{k} \vert {\overline{μ}}_{k} , {( {λ}_{k} {τ}_{k} )}^{- 1} ) , & ( 45 ) \\ {\overline{μ}}_{k} = \frac{{τ}_{0} {μ}_{0} + {𝒮}_{k 1} + {𝒰}_{k 1}}{{\overline{M}}_{k} + {\overline{L}}_{k} + {τ}_{0}} , & ( 46 ) \\ {τ}_{k} = {\overline{M}}_{k} + {\overline{L}}_{k} + {τ}_{0} , & ( 47 ) \\ q ( λ ) = {\prod }_{k = 1}^{K} 𝒢 ( {λ}_{k} \vert {a}_{k} , {b}_{k} ) , & ( 48 ) \\ {a}_{k} = \frac{{\overline{M}}_{k} + {\overline{N}}_{k} + 1}{2} + {a}_{0} , & ( 49 ) \\ {b}_{k} = {b}_{0} + \frac{1}{2} \{ {τ}_{0} {μ}_{0}^{2} + {𝒮}_{k 2} + {𝒰}_{k 2} \} , & ( 50 ) \\ q ( Y , Z ) = q ( Z ) q ( Y \vert Z ) , & ( 51 ) \\ q ( Z ) = {\prod }_{i = 1}^{M} Mult ( {y}_{i} \vert {ρ}_{ik} ) {\prod }_{j = M + 1}^{𝒩} Mult ( {y}_{j} \vert {ϱ}_{k} ) , & ( 52 ) \\ {γ}_{ik} = {𝔼}_{q} [ log {π}_{k} ] - \frac{1}{2} {τ}_{k}^{- 1} + \frac{1}{2} {𝔼}_{q} [ log {λ}_{k} ] - \frac{1}{2} log {\overline{λ}}_{k} + log f ( {x}_{i} \vert {\overline{μ}}_{k} , {\overline{λ}}_{k}^{- 1} ) , & ( 53 ) \\ {\overline{η}}_{k} = {𝔼}_{q} [ log {π}_{k} ] - \frac{1}{2} {τ}_{k}^{- 1} + \frac{1}{2} {𝔼}_{q} [ log {λ}_{k} ] - \frac{1}{2} log {\overline{λ}}_{k} + log ( 1 - F ( C \vert {\overline{μ}}_{k} , {\overline{λ}}_{k}^{- 1} ) ) , & ( 54 ) \\ {ρ}_{ik} ∝ exp ( {γ}_{ik} ) , {ϱ}_{k} ∝ exp ( {η}_{k} ) , & ( 55 ) \\ q ( Y \vert Z ) = {\prod }_{i = M + 1}^{N - M} 𝒯𝒩 ( {y}_{j} \vert {\overline{μ}}_{{z}_{i}} , {\overline{λ}}_{{z}_{j}} , C , ∞ ) . & ( 56 )\end{matrix}$$

The statistics and others in the above equations are as follows:

$$\begin{matrix}[ Formula 52 ] & \\ {\overline{M}}_{k} = {\sum }_{i = 1}^{M} {\overline{z}}_{ik} , {\overline{L}}_{k} = {\sum }_{j = M + 1}^{N} {\overline{z}}_{jk} , & ( 57 ) \\ {\overline{z}}_{ik} = {ρ}_{ik} , {\overline{z}}_{jk} = {ϱ}_{k} , & ( 58 ) \\ {𝒮}_{k 1} = {\sum }_{i = 1}^{M} {\overline{z}}_{ik} {x}_{i} , {𝒰}_{k 1} = {\sum }_{j = M + 1}^{N} {\overline{z}}_{jk} {𝔼}_{{y}_{i} \vert k} [ {y}_{j} ] , & ( 59 ) \\ {𝒮}_{k 2} = {\sum }_{i = 1}^{M} {\overline{z}}_{ik} {x}_{i}^{2} , {𝒰}_{k 2} = {\sum }_{j = M + 1}^{N} {\overline{z}}_{jk} {𝔼}_{{y}_{j} \vert k} [ {y}_{j}^{2} ] , & ( 60 ) \\ {𝔼}_{{y}_{j} \vert k} [ {y}_{j} ] = {\overline{μ}}_{k} + \frac{1}{{τ}_{k}} \frac{f ( C \vert {\overline{μ}}_{k} , {τ}_{k}^{- 1} ) )}{1 - F ( C \vert {\overline{μ}}_{k} , {τ}_{k}^{- 1} ) )} , & ( 61 ) \\ {𝔼}_{{y}_{j} \vert k} [ {y}_{j}^{2} ] = {\overline{μ}}_{k}^{2} + \frac{1}{{τ}_{k}} + \frac{1}{{τ}_{k}} \frac{( C + {\overline{μ}}_{k} ) f ( C \vert {\overline{μ}}_{k} , {τ}_{k}^{- 1} ) )}{1 - F ( C \vert {\overline{μ}}_{k} , {τ}_{k}^{- 1} )} , & ( 62 ) \\ {\overline{λ}}_{k} = {a}_{k} \text{/} {b}_{k} , {𝔼}_{q} [ log {λ}_{k} ] = Ψ ( {a}_{k} ) - log ( {b}_{k} ) , & ( 63 ) \\ {𝔼}_{q} [ log {π}_{k} ] = Ψ ( {α}_{k} ) - Ψ ( {\sum }_{{k}^{′} = 1}^{K} {α}_{{k}^{′}} ) , & ( 64 )\end{matrix}$$

Here,

Ψ(·) [Formula 53]

represents a digamma function. As a result, a batch type VB algorithm is constructed as shown in Algorithm 5.

TABLE 5
Algorithm 5 Batch type VB Algorithm for Gaussian mixture model
for Censored data

```
Input: X, W: input data, C: (right) censored value, K: number
of mixed models, α₀, μ₀, τ₀, a₀, b₀: hyper parameters
Output: {αₖ, ⁻μₖ, τₖ, aₖ, bₖ}ₖ: parameters for minimizing
functional
  Initialize variational parameters {αₖ, ⁻μₖ, τₖ, aₖ, bₖ}
repeat
  VB E-step: Calculate variational parameters ρ₁ₖ, Qₖ related
  to latent variables of observed data and censored data
  using current parameters according to Equation (55)
  VB M-step: Update/Calculate statistics ⁻Mₖ, ⁻Lₖ, Sₖ₁, Sₖ₂,
  Uₖ₁, Uₖ₂ according to Equations (57) (59) (60), and Update
  variational parameters {αₖ, ⁻μₖ, τₖ, aₖ, bₖ} according to
  Equations (44) (46) (47) (49) (50) using the statistics
until Repeat until convergence conditions are satisfied
```

<Sequential Update Type VB Algorithm>

An online algorithm is derived based on the above batch type VB algorithm. Statistics,

M̅ₖ,L̅ₖ,Sₖ₁,Uₖ₁,Sₖ₂,Sₖ₂ [Formula 54]

are expressed in sequential form, as in the online EM algorithm. When a statistic at the time when data xₜ₋₁ is observed is represented by a superscript (t−1), specific sequential calculation equations are given by the following:

[Formula 55]

Mₖ^{(t)}=Mₖ^{(t-1)}+zᵢₖ,Lₖ^{(t)}=(N−M)_{Q}_{ₖ}, (65)

Sₖ₁^{(t)}=Sₖ₁^{(t-1)}+zᵢₖxₜ,Uₖ₁^{(t)}=Lₖ^{(t)} [symbol] _{y|k}[y], (66)

Sₖ₂^{(t)}=Sₖ₂^{(t-1)}+zᵢₖxₜ²,Uₖ₂^{(t)}=Lₖ^{(t)} [symbol] _{y|k}[y²], (67)

Therefore, a sequential update type algorithm is constructed as shown in Algorithm 6. Similarly, it is possible to derive mini-batch type and schedule type algorithms based on the VB algorithm, but they are omitted.

TABLE 6
Algorithm 6 Online VB Algorithm (Sequential update type) for
Censored data

```
Input: N: input data, K: number of mixed models, α₀, μ₀, τ₀,
a₀, b₀: hyper parameters
Output: {αₖ^{(t)}, ⁻μₖ^{(t)}, τₖ^{(t)}, aₖ^{(t)}, bₖ^{(t)}}_{k,t}
  1: Initialize variational parameters {αₖ⁽⁰⁾, ⁻μₖ⁽⁰⁾, τₖ⁽⁰⁾,
aₖ⁽⁰⁾, bₖ⁽⁰⁾} and statistics ⁻Mₖ⁽⁰⁾, ⁻Lₖ⁽⁰⁾, Sₖ₁⁽⁰⁾, Sₖ₂⁽⁰⁾, Sₖ₂⁽⁰⁾,
Sₖ₂⁽⁰⁾, Uₖ₁⁽⁰⁾, Uₖ₂⁽⁰⁾
  2: Initialize number of observed data M ← 0
  3: for t = 1 to N do
  4: Acquire data xₜ
  5: Update number of data and threshold: M ← M + 1, C ← xₜ
  6: VB E-step: Calculate variational paramenters ρₜₖ, Qₖ
    related to latent variables of observed data xₜ and
    censored data according to Equation (55)
  7: VB M-step: Update/Calculate statistics ⁻Mₖ^{(t)}, ⁻Lₖ^{(t)},
    Sₖ₁^{(t)}, Sₖ₂^{(t)}, Uₖ₁^{(t)}, Uₖ₂^{(t)} according to Equations
    (65) (66) (67), and Update variational parameters {αₖ^{(t)},
    ⁻μₖ^{(t)}, τₖ^{(t)}, aₖ^{(t)}, bₖ^{(t)}} according to Equations
    (44) (46) (47) (49) (50) using the statistics
  8: end for
```

<Configuration of Dynamic Distribution Estimation Device 100 of First Embodiment>

A dynamic distribution estimation device 100 according to a first embodiment estimates parameters using a sequential update type online EM algorithm.

As illustrated in FIG. 3, the dynamic distribution estimation device 100 according to the first embodiment is configured to include a computer 10 and an external device 30, and the computer 10 includes a CPU (Central Processing Unit), a RAM (Random Access Memory), and a ROM (Read Only Memory) storing a program for executing a dynamic distribution estimation routine described later. The computer 10 functionally includes a storage unit 12, an initialization processing unit 17, an update processing unit 18, a parameter processing unit 23, and an input/output unit 24.

The storage unit 12 includes a parameter recording unit 13, an observation data number recording unit 14, a threshold recording unit 15, and a statistic recording unit 16.

In the parameter recording unit 13, parameters of a model,

{πₖ⁽⁰⁾,μₖ⁽⁰⁾,σₖ⁽⁰⁾} [Formula 56]

are stored.

In the observation data number recording unit 14, the number M of observed data is stored.

In the threshold recording unit 15, the threshold C for observed data is stored.

In the statistic recording unit 16, statistics,

Mₖ^{(t)},Nₖ^{(t)},Sₖ₁^{(t)},

Sₖ₂^{(t)},Uₖ₁^{(t)},Uₖ₂^{(t)} [Formula 57]

are stored.

The initialization processing unit 17 initializes the variational parameters stored in the parameter recording unit 13 and the statistics stored in the statistic recording unit 16.

The update processing unit 18 estimates online the parameters of a Gaussian mixture model which is for a mixture of a plurality of components and represents a distribution of data to be observed. The update processing unit 18 includes a responsibility update unit 19, a moment update unit 20, a statistic update unit 21, and a parameter update unit 22. The moment update unit 20 is an example of an expected value update unit.

The responsibility update unit 19 updates, based on data xₜ of a newly observed sample, a responsibility representing a degree to which data xₜ of the newly observed sample belongs to each component,

γ(zₜₖ) [Formula 58]

, and a responsibility representing a degree to which the data of each sample not yet observed belongs to each component,

η(zⱼₖ) [Formula 59]

, according to Equations (23) and (24).

The moment update unit 20 updates, in a case of assuming that the data of each unobserved sample belongs to each component, a moment of the data of the unobserved sample,

vₖ(yⱼ;C),ξₖ(yⱼ;C) [Formula 60]

, according to Equations (12) and (13).

The statistic update unit 21 updates, based on a responsibility representing a degree to which data xₜ of the newly observed sample belongs to each component,

γ(zₜₖ) [Formula 61]

, a statistic for the number of samples belonging to each component among the observed samples,

Mₖ^{(t)} [Formula 62]

, according to Equation (23).

The statistic update unit 21 updates a responsibility representing a degree to which the data of each sample not yet observed belongs to each component,

η(zⱼₖ) [Formula 63]

, and a statistic for the number of samples belonging to each component among all the samples,

Nₖ^{(t)} [Formula 64]

, according to Equation (24).

The statistic update unit 21 updates, for each component, based on a responsibility representing a degree to which the newly observed sample data belongs to each component,

γ(zₜₖ) [Formula 65]

, statistics for the data of the observed sample belonging to the corresponding component,

Sₖ₁^{(t)},

Sₖ₂^{(t)} [Formula 66]

, according to Equations (25) and (26).

The statistic update unit 21 updates, for each component, in a case of assuming that the data of each unobserved sample belongs to the corresponding component, based on moments of the data of the unobserved sample,

vₖ(yⱼ;C),ξₖ(yⱼ;C) [Formula 67]

, a statistic for the number of samples belonging to the corresponding component among the observed samples,

Mₖ^{(t)} [Formula 68]

, and a statistic for the number of samples belonging to the corresponding component among all the samples,

Nₖ^{(t)} [Formula 69]

, statistics for the data of the unobserved samples belonging to the corresponding component,

Uₖ₁^{(t)},Uₖ₂^{(t)} [Formula 70]

, according to Equations (27) and (28).

The parameter update unit 22 updates, for each component, based on a statistic for the number of samples belonging to the component, which is updated by the statistic update unit 21, among all the samples,

Nₖ^{(t)} [Formula 71]

, statistics for the data of the observed sample belonging to the component,

Sₖ₁^{(t)},

Sₖ₂^{(t)} [Formula 72]

, and statistics for the data of the unobserved samples belonging to the component,

Uₖ₁^{(t)},Uₖ₂^{(t)} [Formula 73]

, parameters related to the component,

θ={πₖ,μₖ,σₖ}ₖ₌₁^{K} [Formula 74]

, according to Equations (20) to (22).

The input/output unit 24 outputs parameters π^{new}ₖ, μ^{new}ₖ, and (σ^{new}ₖ)² updated by the parameter update unit 22 to the external device 30.

The external device 30 outputs the parameters output from the input/output unit 24 as a result.

<Operation of Dynamic Distribution Estimation Device 100>

Next, the operation of the dynamic distribution estimation device 100 according to the present embodiment will be described. First, the initialization processing unit 17 of the dynamic distribution estimation device 100 initializes the parameters stored in the parameter recording unit 13 and the statistics stored in the statistic recording unit 16. Then, the dynamic distribution estimation device 100 estimates the parameters of the model, the number of observation data, the threshold, and the statistics using the EM algorithm based on the already observed data, and stores them in the parameter recording unit 13, the observation data number recording unit 14, the threshold recording unit 15, and the statistic recording unit 16. Then, when the newly observed data xₜ is input, the dynamic distribution estimation device 100 executes a dynamic distribution estimation process routine illustrated in FIG. 4.

First, in step S100, the newly observed data xₜ is acquired.

In step S102, the number M of observation data and the threshold C are updated.

In step S104, the responsibility update unit 19 updates a responsibility γ(zₜ) according to Equation (10) based on data xₜ acquired in step S100. Further, the responsibility update unit 19 updates the responsibility η(zⱼ) according to Equation (11) based on data xₜ acquired in step S100.

In step S106, the moment update unit 20 updates moments vₖ(yⱼ; xₜ) and ξₖ(yⱼ; xₜ) according to Equations (12) and (13) based on data xₜ acquired in step S100.

In step S108, the statistic update unit 21 updates a statistic M^{(t)} k for the number of samples belonging to each component among the observed samples according to Equation (23) based on the responsibility γ(zₜ) updated in step S104. Further, the statistic update unit 21 updates a statistic N^{(t)}ₖ for the number of samples belonging to each component among all the samples according to Equation (24) based on the responsibility η(zⱼ) updated in step S104. Further, the statistic update unit 21 updates, for each component, statistics S^{(t)}ₖ₁ and S^{(t)}ₖ₂ of the data of the observed sample belonging to the corresponding component according to Equations (25) and (26) based on the responsibility γ(zₜ) updated in step S104. Further, the statistic update unit 21 updates, for each component, the statistics U^{(t)}ₖ₁ and U^{(t)}ₖ₂ of the data of the not yet observed sample belonging to the corresponding component according to Equations (27) and (28) based on the moments vₖ(yⱼ; xₜ) and ξₖ(yⱼ; xₜ) updated in step S106 and the updated statistics M^{(t)}ₖ and N^{(t)}ₖ.

In step S110, the input/output unit 24 outputs the parameters π^{new}ₖ, μ^{new}ₖ and (σ^{new}ₖ)² updated in step S110 to the external device 30, and then the processing ends.

As described above, according to the dynamic distribution estimation device according to the first embodiment, the parameters of the Gaussian mixture model that is for a mixture of a plurality of components and represents a distribution of data to be observed data, are estimated online. Specifically, the dynamic distribution estimation device according to the first embodiment updates a responsibility based on data xₜ of the newly observed sample, updates a moment of the data of the unobserved sample, updates each statistic based on at least one of the responsibility and the moment, and updates a parameter related to a component based on each statistic. As a result, it is possible to estimate the parameters of the model at high speed, with a saved memory, and with the parameters having temporal continuity, using an online algorithm for censored data.

Thus, the present embodiment has three advantages of high speed, memory saving, and parameters having temporal continuity, as compared to the batch type estimation algorithm.

Note that the present invention is not limited to the above-described embodiment, and various modifications and applications are possible without departing from the scope and spirit of the present invention.

For example, the description in the above-described first embodiment is for a case where the sequential update online EM algorithm is used in which the parameter update timing is a timing at which data of a newly observed sample is obtained by way of example, but does not limit any embodiment. For example, the mini-batch type online EM algorithm may be used in which the parameter update timing is a timing at which a predetermined number of pieces of data of a newly observed sample are obtained. In this case, the responsibility and the moment may be updated based on the predetermined number of pieces of data xₜ of the newly observed sample according to Algorithm 3 described above, each statistic may be updated based on at least one of the responsibility and the moment, and parameters related to a component may be updated based on each statistic.

Further, a mini-batch type online EM algorithm may be used in which the parameter update timing is a timing at which a predetermined update time is reached. In this case, the responsibility and the moment may be updated based on data xₜ of samples newly observed until the update time is reached according to Algorithm 4 described above, each statistic may be updated based on at least one of the responsibility and the moment, and parameters related to a component may be updated based on each statistic.

<Configuration of Dynamic Distribution Estimation Device of Second Embodiment>

A dynamic distribution estimation device according to a second embodiment estimates parameters using a sequential update type online VB algorithm.

As illustrated in FIG. 5, a dynamic distribution estimation device 200 according to the second embodiment is configured to include a computer 210 and an external device 30, and the computer 210 includes a CPU (Central Processing Unit), a RAM (Random Access Memory), and a ROM (Read Only Memory) storing a program for executing a dynamic distribution estimation routine described later. The computer 210 functionally includes a storage unit 212, an initialization processing unit 217, an update processing unit 218, a parameter processing unit 23, and an input/output unit 24.

The storage unit 12 includes a parameter recording unit 213, an observation data number recording unit 14, a threshold recording unit 15, and a statistic recording unit 216.

In the parameter recording unit 213, variational parameters,

{αₖ^{(t)},μ̅ₖ^{(t)},τₖ^{(t)},aₖ^{(t)},bₖ^{(t)}}k,t [Formula 75]

are stored.

In the statistic recording unit 216, statistics,

M̅ₖ^{(t)},L̅ₖ^{(t)},Sₖ₁^{(t)},Sₖ₂^{(t)},Uₖ₁^{(t)},Uₖ₂^{(t)} [Formula 76]

are stored.

The initialization processing unit 217 initializes the variational parameters stored in the parameter recording unit 213 and the statistics stored in the statistic recording unit 16.

The update processing unit 218 estimates online the parameters of a Gaussian mixture model which is for a mixture of a plurality of components and represents a distribution of data to be observed. The update processing unit 218 includes a latent variable parameter update unit 219, a statistic update unit 221, and a parameter update unit 222.

The latent variable parameter update unit 219 updates, based on data xₜ of a newly observed sample, a parameter of a variational distribution related to a latent variable of each component for the newly observed sample data xₜ,

z̅ᵢₖ=ρᵢₖ [Formula 77]

, and a parameter of a variational distribution related to a latent variable of each component for data of a set of already observed samples including the newly observed sample,

z̅ⱼₖ= [symbol] ₖ [Formula 78]

, according to Equation (55).

The statistic update unit 221 updates, based on a parameter of the variational distribution updated by the latent variable parameter update unit 219,

z̅ᵢₖ=ρᵢₖ [Formula 79]

, a statistic for the number of samples belonging to each component among the observed samples,

M̅ₖ [Formula 80]

, according to Equation (57).

Further, the statistic update unit 221 updates, based on a parameter of the variational distribution updated by the latent variable parameter update unit 219,

z̅ⱼₖ= [symbol] ₖ [Formula 81]

, a statistic for the number of samples belonging to each component among the unobserved samples,

L̅ₖ [Formula 82]

, according to Equation (57).

Further, the statistic update unit 221 updates, based on a parameter of the variational distribution updated by the latent variable parameter update unit 219,

z̅ᵢₖ=ρᵢₖ [Formula 83]

, statistics for the data of the observed sample belonging to the corresponding component,

Sₖ₁,Sₖ₂ [Formula 84]

, according to Equations (59) and (60).

Further, the statistic update unit 221 updates, based on

z̅ⱼₖ= [symbol] ₖ [Formula 85]

, statistics for the data of the unobserved samples belonging to the corresponding component,

Uₖ₁,Uₖ₂ [Formula 86]

, according to Equations (59) and (60).

The parameter update unit 222 updates, for each component, based on a statistic for the number of samples updated by the statistic update unit 221, among all the samples,

M̅ₖ

L̅ₖ [Formula 87]

, statistics of the data of the observed sample belonging to the corresponding component and updated by the statistic update unit 221,

Sₖ₁,Sₖ₂ [Formula 88]

, and statistics for the data of the unobserved samples belonging to the corresponding component,

Uₖ₁,Uₖ₂ [Formula 89]

, parameters of the variational distribution related to the parameters of the corresponding component,

{αₖ,μ̅ₖ,τₖ,aₖ,bₖ} [Formula 90]

, according to Equations (44) to (50).

The parameter processing unit 223 controls the related units so that the updating by the latent variable parameter update unit 219, the updating by the statistic update unit 221, and the updating by the parameter update unit 222 are repeated every time a predetermined parameter update timing is reached. For example, the parameter processing unit 223 controls the units so that the updating by the latent variable parameter update unit 219, the updating by the statistic update unit 221, and the updating by the parameter update unit 222 are repeated at the time when data of a newly observed sample is acquired as the predetermined parameter update timing.

<Operation of Dynamic Distribution Estimation Device 200>

Next, the operation of the dynamic distribution estimation device 200 according to the present embodiment will be described. First, the initialization processing unit 17 of the dynamic distribution estimation device 200 initializes the parameters stored in the parameter recording unit 213 and the statistics stored in the statistic recording unit 216. Then, the dynamic distribution estimation device 200 estimates the parameters of the model, the number of observation data, the threshold, and the statistics using the VB algorithm based on the already observed data, and stores them in the parameter recording unit 213, the observation data number recording unit 14, the threshold recording unit 15, and the statistic recording unit 216. Then, when the newly observed data xₜ is input, the dynamic distribution estimation device 200 executes a dynamic distribution estimation process routine illustrated in FIG. 6.

First, in step S100, the newly observed data xₜ is acquired.

In step S102, the number M of observation data and the threshold C are updated.

In step S204, the latent variable parameter update unit 219 updates, based on data xₜ of the newly observed sample, parameters of the variational distribution related to the latent variables,

z̅ᵢₖ=ρᵢₖ

z̅ⱼₖ= [symbol] ₖ [Formula 91]

, according to Equation (55).

In step S206, the statistic update unit 221 updates, based on the parameters of the variational distribution updated in step S204.

In step S208, the statistic update unit 21 updates, based on the responsibility γ(zₜ) updated in step S104, statistics,

M̅ₖ^{(t)},L̅ₖ^{(t)},Sₖ₁^{(t)},Sₖ₂^{(t)},Uₖ₁^{(t)},Uₖ₂^{(t)} [Formula 92]

are updated according to Equations (44) to (50).

In step S210, the input/output unit 24 outputs the parameters updated in step S208,

{αₖ^{(t)},μ̅ₖ^{(t)},τₖ^{(t)},aₖ^{(t)},bₖ^{(t)}} [Formula 93]

to the external device 30, and then the processing ends.

As described above, according to the dynamic distribution estimation device according to the second embodiment, the parameters of the Gaussian mixture model that is for a mixture of a plurality of components and represents a distribution of data to be observed data, are estimated online. Specifically, the dynamic distribution estimation device according to the second embodiment updates parameters of a variational distribution related to latent variables and variational parameters based on data xₜ of the newly observed sample, updates each statistic based on at least one of: the parameters of the variational distribution related to the latent variables and the variational parameters, and updates the parameters related to the components based on the respective statistics. As a result, when a VB algorithm is used, it is possible to estimate the parameters of the model at high speed, with a saved memory, and with the parameters having temporal continuity.

Note that the present invention is not limited to the above-described embodiment, and various modifications and applications are possible without departing from the scope and spirit of the present invention.

For example, the description in the above-described second embodiment is for a case where the sequential update online VB algorithm is used in which the parameter update timing is a timing at which data of a newly observed sample is obtained by way of example, but does not limit any embodiment. For example, the mini-batch type online VB algorithm may be used in which the parameter update timing is a timing at which a predetermined number of pieces of data of a newly observed sample are obtained. In this case, the parameters of a variational distribution related to latent variables and variational parameters may be updated based on a predetermined number of pieces of data xₜ of the newly observed sample, each statistic may be updated based on at least one of: the parameters of the variational distribution related to the latent variables and the variational parameters, and the parameters related to the components may be updated based on the respective statistics.

Further, a mini-batch type online VB algorithm may be used in which the parameter update timing is a timing at which a predetermined update time is reached. In this case, the parameters of a variational distribution related to latent variables and variational parameters may be updated based on data xₜ of samples newly observed until the update time is reached, each statistic may be updated based on at least one of: the parameters of the variational distribution related to the latent variables and the variational parameters, and the parameters related to the components may be updated based on the respective statistics.

Further, the description in the above-described embodiments is for a case where the Gaussian distribution is used as a distribution for a component by way of example. However, it does not limit any embodiment but includes a case where an arbitrary exponential distribution family is used. The exponential distribution family, a density function is represented by the following Equation (67).

[Formula 94]

f_{E}(x|φ)=h(x)exp(φ·T(x)−A(φ)) (67)

φ [Formula 95]

is a natural parameter, T(x) is a sufficient statistic, h(x) is a base measure,

A(φ) [Formula 96]

is a known function called a logarithmic distribution function, and the symbol “•” in the equation represents an inner product of vectors. The Gaussian distribution is also a probability distribution belonging to the exponential distribution family, and when a natural parameter, a sufficient statistic, a base measure, and a logarithmic distribution function are defined as in the following Equation (68), the density function of the Gaussian distribution represented in Equation (2) is equal to Equation (67).

$$\begin{matrix} [ Formula 97 ] & \\ T ( x ) = {( x , {x}^{2} )}^{T} , ϕ = {( {μ}_{k} \text{/} {σ}_{k}^{2} , - 1 \text{/} ( 2 {σ}_{k}^{2} ) )}^{T} , h ( x ) = \frac{1}{\sqrt{2 π}} , A ( ϕ ) = \frac{{ϕ}_{1}^{2}}{4 {ϕ}_{2}} - \frac{1}{2} log ( - 2 {ϕ}_{2} ) & ( 68 )\end{matrix}$$

Based on this, the moments of the truncated normal distribution calculated in the estimation algorithm of the Gaussian mixture model (Equations (12) and (13), (61) and (62)) are, when the normal distribution is expressed in the form of an exponential distribution family, regarded as expected values calculated when x of the values corresponding to the respective dimensions (x and square of x) of the sufficient statistic T (x) follows the truncated normal distribution. Even when a distribution belonging to an exponential distribution other than the Gaussian distribution is used as the component distribution, replacing the process of calculating the moments with a process of calculating the expected values for the truncated distribution of the values corresponding to the respective dimensions of the sufficient statistic makes it possible to perform the estimation in the same manner as in the case of the Gaussian mixture model. Note that the statistic update unit 221 that calculates Equations (61) and (62) is an example of an expected value update unit.

Further, the present invention can be realized by installing a program on a known computer via a medium or a communication line.

Further, the above-described device includes a computer system inside, but such a “computer system” includes a homepage providing environment (or display environment) if a WWW system is used.

Further, in the description of the present application, the embodiments are described in which the program is installed in advance. However, the program may be stored in a computer-readable recording medium and provided.

### REFERENCE SIGNS LIST

10, 210 Computer
12, 212 Storage unit
13, 213 Parameter recording unit
14 Observation data number recording unit
15 Threshold recording unit
16, 216 Statistic recording unit
17, 217 Initialization processing unit
18, 218 Update processing unit
19 Responsibility update unit
20 Moment update unit
21, 221 Statistic update unit
22, 222 Parameter update unit
23, 223 Parameter processing unit
24 Input/output unit
30 External device
100, 200 Dynamic distribution estimation device
219 Latent variable parameter update unit

1-8. (canceled)

9. A computer-implemented method for dynamically estimating distribution of data with truncated data based on a mixture model, the method comprising:
receiving a set of newly observed data;
updating, based on the received set of newly observed data, a number of the received set of observed data;
updating, based on the received set of newly observed data, a threshold of truncated data;
updating one or more expectation values for the distribution including components with truncated data;
updating one or more statistics of one or more components of data based on the updated one or more expectation values;
updating one or more parameters of a distribution model based on the updated one or more statistics; and
providing the updated one or more parameters of the distribution model as an estimated distribution of data with the truncated data.

10. The computer-implemented method of claim 9, wherein the mixture model is one of a Gaussian mixture model, or a mixture of arbitrary distributions belonging to an exponential distribution family.

11. The computer-implemented method of claim 9, the method further comprising:
updating, based on the received set of newly observed data, one or more responsibility values according to the expectation-maximization (EM) algorithm, wherein the one or more responsibility values indicate a degree of;
updating, based on the received set of newly observed data, one or more moment values according to the EM algorithm, wherein the one or more expectation values include the one or more responsibility values and the one or more moment values;
updating, based at least on the updated one or more moment values, statistics of unobserved data in the one or more components; and
upon a predetermined timing, repeating the updating the one or more responsibility values, the updating the one or more moment values, and the updating the statistics of the unobserved data.

12. The computer-implemented method of claim 11, wherein each of the one or more responsibility of data indicates one of:
a first degree to which each of the set of the newly observed data belongs to each component, or
a second degree to which each of the set of the unobserved data belongs to each component.

13. The computer-implemented method of claim 11, wherein the predetermined timing is one or more of:
upon receiving the newly observed data;
upon a number of accumulating newly observed data reaching a predetermined number of accumulated the newly observed data; and
a predetermined time.

14. The computer-implemented method of claim 9, the method further comprising:
updating, based on the received set of newly observed data, one or more parameters of a variational distribution that relates to latent variable according to variational Bayesian (VB) algorithm; and
upon a predetermined timing, repeating the updating the one or more parameters of the variational distribution.

15. The computer-implemented method of claim 14, wherein the predetermined timing is one or more of:
upon receiving the newly observed data;
upon a number of accumulating newly observed data reaching a predetermined number of accumulated the newly observed data; and
a predetermined time.

16. A system for dynamically estimating distribution of data with truncated data based on a mixture model, the system comprising:
a processor; and
a memory storing computer-executable instructions that when executed by the processor cause the system to:
receive a set of newly observed data;
update, based on the received set of newly observed data, a number of the received set of observed data;
update, based on the received set of newly observed data, a threshold of truncated data;
update one or more expectation values for the distribution including components with truncated data;
update one or more statistics of one or more components of data based on the updated one or more expectation values;
update one or more parameters of a distribution model based on the updated one or more statistics; and
provide the updated one or more parameters of the distribution model as an estimated distribution of data with the truncated data.

17. The system of claim 16, wherein the mixture model is one of a Gaussian mixture model, or a mixture of arbitrary distributions belonging to an exponential distribution family.

18. The system of claim 16, the computer-executable instructions when executed further causing the system to:
update, based on the received set of newly observed data, one or more responsibility values according to the expectation-maximization (EM) algorithm, wherein the one or more responsibility values indicate a degree of;
update, based on the received set of newly observed data, one or more moment values according to the EM algorithm, wherein the one or more expectation values include the one or more responsibility values and the one or more moment values;
update, based at least on the updated one or more moment values, statistics of unobserved data in the one or more components; and
upon a predetermined timing, repeat the updating the one or more responsibility values, the updating the one or more moment values, and the updating the statistics of the unobserved data.

19. The system of claim 18, wherein each of the one or more responsibility of data indicates one of:
a first degree to which each of the set of the newly observed data belongs to each component, or
a second degree to which each of the set of the unobserved data belongs to each component.

20. The system of claim 18, wherein the predetermined timing is one or more of:
upon receiving the newly observed data;
upon a number of accumulating newly observed data reaching a predetermined number of accumulated the newly observed data; and
a predetermined time.

21. The system of claim 16, the computer-executable instructions when executed further causing the system to:
update, based on the received set of newly observed data, one or more parameters of a variational distribution that relates to latent variable according to variational Bayesian (VB) algorithm; and
upon a predetermined timing, repeat the updating the one or more parameters of the variational distribution.

22. The system of claim 21, wherein the predetermined timing is one or more of:
upon receiving the newly observed data;
upon a number of accumulating newly observed data reaching a predetermined number of accumulated the newly observed data; and
a predetermined time.

23. A computer-readable non-transitory recording medium storing computer-executable instructions that when executed by a processor cause a computer system to:
receive a set of newly observed data;
update, based on the received set of newly observed data, a number of the received set of observed data;
update, based on the received set of newly observed data, a threshold of truncated data;
update one or more expectation values for the distribution including components with truncated data;
update one or more statistics of one or more components of data based on the updated one or more expectation values;
update one or more parameters of a distribution model based on the updated one or more statistics; and
provide the updated one or more parameters of the distribution model as an estimated distribution of data with the truncated data.

24. The computer-readable non-transitory recording medium of claim 23, wherein the mixture model is one of a Gaussian mixture model, or a mixture of arbitrary distributions belonging to an exponential distribution family.

25. The computer-readable non-transitory recording medium of claim 23, the computer-executable instructions when executed further causing the system to:
update, based on the received set of newly observed data, one or more responsibility values according to the expectation-maximization (EM) algorithm, wherein the one or more responsibility values indicate a degree of;
update, based on the received set of newly observed data, one or more moment values according to the EM algorithm, wherein the one or more expectation values include the one or more responsibility values and the one or more moment values;
update, based at least on the updated one or more moment values, statistics of unobserved data in the one or more components; and
upon a predetermined timing, repeat the updating the one or more responsibility values, the updating the one or more moment values, and the updating the statistics of the unobserved data.

26. The computer-readable non-transitory recording medium of claim 25, wherein each of the one or more responsibility of data indicates one of:
a first degree to which each of the set of the newly observed data belongs to each component, or
a second degree to which each of the set of the unobserved data belongs to each component.

27. The computer-readable non-transitory recording medium of claim 25, wherein the predetermined timing is one or more of:
each time receiving the newly observed data;
a time of a number of stored newly observed data reaching a predetermined number of the newly observed data; and
a predetermined time.

28. The computer-readable non-transitory recording medium of claim 23, the computer-executable instructions when executed further causing the system to:
update, based on the received set of newly observed data, one or more parameters of a variational distribution that relates to latent variable according to variational Bayesian (VB) algorithm; and
upon a predetermined timing, repeat the updating the one or more parameters of the variational distribution.
